(19) United States
(12) Patent Application Publication
(10) Pub. No.: US 2026/0179958 A1
(43) Pub. Date: Jun. 25, 2026

(54) CONDUCTIVE MATERIAL HAVING SELF-HEALING FUNCTION, MANUFACTURING METHOD THEREOF, AND USE THEREOF

(71) Applicants: HYUNDAI MOTOR COMPANY, Seoul (KR); KIA CORPORATION, Seoul (KR); POSTECH Research and Business Development Foundation, Pohang-si (KR)

(72) Inventors: Taerim Lee, Hwaseong-si (KR); Yongho Lee, Hwaseong-si (KR); Dongjoo Kim, Pohang-si (KR); Sungho Kim, Pohang-si (KR); Soojin Park, Pohang-si (KR); Jieun Kang, Pohang-si (KR)

(73) Assignees: HYUNDAI MOTOR COMPANY, Seoul (KR); KIA CORPORATION, Seoul (KR); POSTECH Research and Business Development Foundation, Pohang-si (KR)

(21) Appl. No.: 19/181,204

(22) Filed: Apr. 16, 2025

(30) Foreign Application Priority Data
Dec. 19, 2024 (KR) 10-2024-0191377

(51) Int. Cl. H01M 4/62; C01B 32/174; H01M 4/02; H01M 10/0525

(52) U.S. Cl. CPC H01M 4/625; C01B 32/174; H01M 10/0525; C01B 2202/02; C01P 2002/85; C01P 2002/88; C01P 2006/40; H01M 2004/027

(57) ABSTRACT

A conductive material having a self-healing function, a manufacturing method thereof, and a use thereof. The conductive material is capable of self-healing a deteriorated negative electrode material, ionic conductivity of an electrode, and also has high water dispersibility.

### CROSS-REFERENCE TO RELATED APPLICATION

This present application claims the benefit of priority to Korean Patent Application No. 10-2024-0191377, entitled “CONDUCTIVE MATERIAL HAVING SELF-HEALING FUNCTION MANUFACTURING METHOD THEREOF, AND USE THEREOF,” filed on Dec. 19, 2024, in the Korean Intellectual Property Office, the entire disclosure of which is incorporated herein by reference.

### FIELD

The present disclosure relates to a conductive material having a self-healing function, a manufacturing method thereof, and a use thereof.

### BACKGROUND

Lithium-ion batteries have been studied for the past few decades in an effort to target more stable performance relative to conventional electrochemical characteristics while increasing the energy density. Accordingly, researchers have focused on silicon negative electrode active materials with high capacity. During lithium-ion battery electrode manufacturing processes, the dispersibility of electrode material particles during the preparation of an electrode slurry has a large impact on the electrochemical performance of the battery. Conventional conductive materials such as carbon black or carbon nanofibers have physical structures that are difficult to disperse in a liquid or solvent, and thus have limitations in achieving uniform battery performance. In particular, the low dispersibility of such conductive materials can cause a decrease in electrical conductivity, which leads to non-uniform battery performance as well as reduced cycle performance of the battery.

Silicon-based negative electrode materials are promising materials capable of improving the energy density of lithium secondary batteries, and provide significantly higher capacity than conventional graphite negative electrodes. However, when these materials react with lithium, a volume expansion of about 300% or more occurs, which causes problems such as separation of electrode materials, peeling from current collectors, short circuit in conductivity, and formation of an unstable solid electrolyte interface (SEI), all of which can result in serious deterioration of the battery. Therefore, a need remains for the continued development of effective conductive materials in order to address the problems associated with the silicon negative electrode materials in the state of the art.

Carbon nanotubes (CNTs) have a light weight, high electrical conductivity, and excellent flexibility, and as such have potential as effective conductive materials for silicon negative electrodes. However, CNTs have very poor dispersibility in solvents, such as water, which makes it difficult to form effective conductive paths in the electrode. In particular, as multi-walled carbon nanotubes (MWCNTs) can create side reactions with lithium ions that have negative effects on battery performance, further research on materials comprising single-walled carbon nanotubes (SWCNTs) is needed.

As described herein, a uniform slurry is achieved by introducing functional polymers into single-walled carbon nanotube conductive materials, that can alleviate conductivity short-circuiting due to electrode extension, and secure reduced interfacial resistance and improve battery life.

### SUMMARY

In a general sense the present disclosure provides a conductive material capable of simultaneously securing excellent self-healing performance and water dispersibility, a manufacturing method thereof, and a use thereof.

In an aspect the present disclosure provides a conductive material that may be applied to green technology fields such as batteries for electric vehicles.

In such aspects, the present disclosure provides a conductive material comprising a carbon material; and a polymer containing a functional group capable of hydrogen bonding, in which the carbon material is grafted with the polymer containing the functional group capable of hydrogen bonding.

In some example embodiments of the present disclosure, the carbon material may comprise at least one of single-walled carbon nanotubes, carbon black, and/or carbon fibers. In some example embodiments of the present disclosure, the carbon material may be selected from the group consisting of single-walled carbon nanotubes, carbon black, and carbon fibers.

In some example embodiments of the present disclosure, the single-walled carbon nanotubes may be surface-modified with hydroxyl groups or carboxyl groups.

In some example embodiments of the present disclosure, the functional group capable of hydrogen bonding may comprise at least one of a hydroxyl group, an amide group, and/or an ester group. In some example embodiments of the present disclosure, the functional group capable of hydrogen bonding may be selected from the group consisting of a hydroxyl group, an amide group, and an ester group.

According to an example embodiment of the present disclosure, the polymer containing the functional group capable of hydrogen bonding may comprise at least one repeating monomer units represented by Chemical Formula 1 and/or Chemical Formula 2:

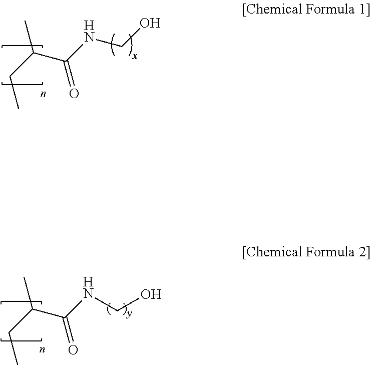

wherein, x and y are each independently integers of 1 to 6, and
n may be 1 to 20.

According to an example embodiment of the present disclosure, the conductive material may comprise 1 to 30 parts by weight of the polymer containing the functional group capable of hydrogen bonding with respect to 100 parts by weight of the carbon material.

Another aspect of the present disclosure provides a negative electrode comprising the conductive material as generally described in the aspects and embodiments herein; and a binder.

According to an example embodiment of the present disclosure, the binder may form hydrogen bonds with the conductive material.

Yet another aspect of the present disclosure provides a lithium ion battery comprising the negative electrode as generally described in the aspects and embodiments.

Still another aspect of the present disclosure provides a manufacturing method of a conductive material comprising: preparing a carbon material solution by mixing a carbon material with a solvent; grafting polymer monomer units onto the carbon material by adding the polymer monomer units to the carbon material solution; and polymerizing the polymer monomer units by adding an initiator to the grafted solution, wherein the polymer monomer units contain a functional group capable of hydrogen bonding.

According to an example embodiment of the present disclosure, the manufacturing method of the conductive material may further comprise surface-modifying the carbon material before the preparing of the carbon material solution.

According to an example embodiment of the present disclosure, the monomer may comprise N-(hydroxymethyl) acrylamide, 2-hydroxyethyl acrylate, or a combination thereof.

According to an example embodiment of the present disclosure, the weight ratio of the carbon material, the polymer monomer units, and the initiator may be in a range of 1-5 to 20-0.05 to 0.2, (carbon material to polymer monomer units to initiator).

The aspects and embodiments of the present disclosure can provide a conductive material capable of self-healing a deteriorated negative electrode material.

The aspects and embodiments of the present disclosure can provide a conductive material capable of improving ionic conductivity of an electrode while having high water dispersibility.

### BRIEF DESCRIPTION OF THE DRAWINGS

The above and other aspects, features, and advantages of the present disclosure will become apparent from the detailed description that follows as well as the accompanying drawings, in which:

FIG. 1 depicts an image showing a conductive material having a self-healing function according to some aspects and embodiments of the present disclosure;

FIG. 2 shows results of a water dispersibility experiment of conductive materials according to the illustrative Example and Comparative Example in accordance with some aspects and embodiments of the disclosure;

FIG. 3 is a graph showing thermogravimetric analysis (TGA) results of conductive materials according to the illustrative Example and Comparative Example in accordance with some aspects and embodiments of the disclosure;

FIG. 4 is a graph showing X-ray photoelectron spectroscopy (XPS) results of conductive materials according to the illustrative Example and Comparative Example in accordance with some aspects and embodiments of the disclosure;

FIG. 5 shows a result of evaluating the adhesion strength of electrodes according to the illustrative Example and Comparative Example in accordance with some aspects and embodiments of the disclosure;

FIG. 6 shows a result of evaluating the life stability of batteries comprising conductive materials according to the illustrative Example and Comparative Example in accordance with some aspects and embodiments of the disclosure;

FIG. 7 shows a result of evaluating the extension of electrodes comprising conductive materials according to the illustrative Example and Comparative Example in accordance with some aspects and embodiments of the disclosure; and

FIG. 8 shows a result of evaluating the impedance performance of batteries comprising conductive materials according to the illustrative Example and Comparative Example in accordance with some aspects and embodiments of the disclosure.

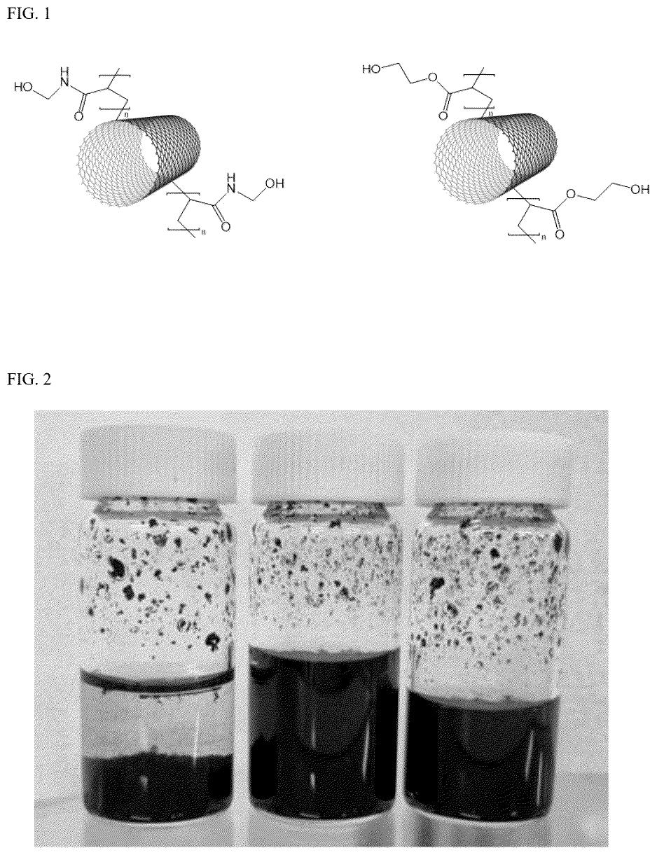

### DETAILED DESCRIPTION

The following aspects and embodiments provide a reference for explaining the present disclosure in detail, and the disclosure is not limited thereto, and may be implemented in various forms and equivalents thereof.

Unless defined otherwise by the disclosure, all technical and scientific terms used herein should be given their ordinary and customary meaning as commonly understood by one of ordinary skill in the art to which the disclosure belongs. A number of terms and abbreviations appear throughout the disclosure and, unless otherwise defined or indicated, should be understood to have their reasonably broad commonly understood and plain meanings that are consistent with the context in which the terms are used.

As used herein, referent terms such as “first,” “second,” “initial,” “subsequent,” and the like, may be used for describing various components, but the components are not limited by the terms. These terms are only used to distinguish one component from another component. For example, without departing from the scope of the present disclosure, a first component may be named as a second component, and similarly, a second component may be named as a first component.

The terms used herein are used for describing particular embodiments only and are not intended to limit the present disclosure. A singular expression includes a plural expression unless otherwise defined differently in a context. In the present disclosure, it should be understood that term “comprising” or “having” or “including” indicates that a feature, a number, a step, an operation, a component, a part or a combination thereof described in the specification is present, but does not exclude a possibility of presence or addition of one or more other features, numbers, steps, operations, components, parts or combinations thereof, in advance. It will be appreciated that those terms are also inclusive of the term “consisting of” or “consisting essentially of” which, when used throughout the disclosure or claims, generally indicate that a feature, a number, a step, an operation, a component, a part or a combination thereof described in the specification is present, and does not include any additional feature(s).

In addition, units used herein without special mention are based on weight, and for example, units of % or ratio mean wt % or weight ratio, and wt % means wt % of any one component in the entire composition, unless otherwise defined.

Hereinafter, the present disclosure will be described in more detail.

The present disclosure relates to a conductive material comprising a carbon material; and a polymer containing a functional group capable of hydrogen bonding, in which the carbon material is grafted with the polymer containing the functional group capable of hydrogen bonding, a manufacturing method thereof, and a use thereof. In some embodiments, the conductive material may comprise the carbon material which is grafted with the polymer capable of forming hydrogen bonds, to form hydrogen bonds with a silicon material and a binder, thereby significantly improving the bonding strength of electrode materials. In addition, the hydrogen bond-based dynamic secondary interactions that can form allows for self-healing of the material even if bonds between electrode materials are broken due to a volume change of the negative electrode during battery charging and discharging. Meanwhile, the polymer containing the functional group capable of hydrogen bonding contains hydrophilic functional groups, thereby securing excellent dispersibility in an aqueous-based slurry.

In an aspect, the present disclosure provides a conductive material comprising a carbon material; and a polymer containing a functional group capable of hydrogen bonding, in which the carbon material is grafted with the polymer containing the functional group capable of hydrogen bonding.

In one example embodiment of the present disclosure, the carbon material may comprise at least one of single-walled carbon nanotubes, carbon black, and/or carbon fibers, and in some preferred embodiments, single-walled carbon nanotubes as single-walled carbon nanotubes have a light weight, high electrical conductivity, and flexibility, and do not cause side reactions with lithium ions-all favorable properties for a conductive material for a silicon negative electrode.

In one example embodiment of the present disclosure, the single-walled carbon nanotubes may be surface-modified with hydroxyl groups or carboxyl groups. In such embodiments, the surface-modified single-walled carbon nanotubes can have excellent water dispersibility to efficiently perform a grafting process and may provide sites where monomers or polymers are grafted.

In one example embodiment of the present disclosure, the functional group capable of hydrogen bonding may comprise at least one of a hydroxyl group, an amide group, and/or an ester group, but is not limited thereto.

In one example embodiment of the present disclosure, the polymer containing the functional group capable of hydrogen bonding may comprise repeating units represented by at least one of Chemical Formula 1 and/or Chemical Formula 2:

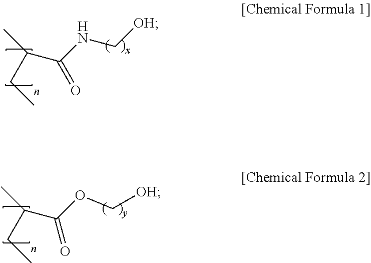

and wherein x and y are each independently integers from 1 to 6, and
n may be 1 to 20.

In some embodiments, x may be 1 to 4, y may be 2 to 4, and n may be 1 to 10, but are not limited thereto as long as the purpose and function as described in the present disclosure is obtained.

In one example embodiment of the present disclosure, when x is 1, the repeating unit may be represented by Chemical Formula 3, and in another embodiments when y is 2, the repeating unit may be represented by Chemical Formula 4:

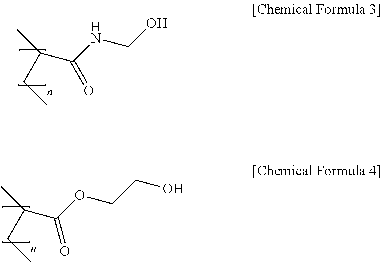

and wherein n is as defined in Chemical Formulae 1 and 2.

In one example embodiment of the present disclosure, the conductive material may comprise 1 to 30 parts by weight of the polymer containing the functional group capable of hydrogen bonding with respect to 100 parts by weight of the carbon material.

In further aspects, the present disclosure provides a negative electrode comprising the conductive material in accordance with the aspects and embodiments described herein; and a binder.

In one example embodiment of the present disclosure, the binder may form hydrogen bonds with the conductive material. In such embodiments, the bonding strength of the electrode materials may be significantly improved, and a strong interaction may be created between the electrode materials that can impart a self-healing property to the electrode materials.

Typically, the binder is not particularly limited and can comprise any material tat can form hydrogen bonds with the conductive material. In one example embodiment of the present disclosure, the binder may comprise at least one of poly(vinylidene fluoride-co-hexafluoropropylene), poly(acrylic acid), carboxymethyl cellulose, poly(vinyl alcohol), Nafion, and/or gelatin, as some non-limiting examples.

In one example embodiment of the present disclosure, the negative electrode may further comprise a negative electrode active material.

In one example of the present disclosure, the negative electrode active material may comprise SiOₓ (0<x<2) and may further comprise one or more of natural graphite, artificial graphite, and/or Si/C. In such embodiments, the negative electrode active material may form hydrogen bonds with the conductive material and the binder, thereby significantly improving the bonding strength and self-healing property of the electrode material.

In a further aspect, the present disclosure provides a lithium ion battery comprising the negative electrode in accordance with the aspects and embodiments described herein.

In one example embodiment of the present disclosure, the lithium ion battery may further comprise a positive electrode, an electrolyte, and a separator. The positive electrode, the electrolyte, and the separator, in accordance with the aspects and embodiments of the disclosure, are not particularly limited and may include any such components that are generally known in the art.

In another aspect, the present disclosure provides a method for manufacturing a conductive material comprising: preparing a carbon material solution by mixing a carbon material with a solvent; grafting monomers (or as alternatively used herein, “polymer monomers”, “polymer monomer units”, and the like) onto the carbon material by adding the monomers to the carbon material solution; and polymerizing a polymer by adding an initiator to the grafted solution.

In the description of the manufacturing method of the conductive material, the content for the conductive material forming part of the method can be referred to and incorporated from the aspects and embodiments of the conductive materials disclosed herein, and will not be repeated.

In one example embodiment of the present disclosure, the monomer may contain a functional group capable of hydrogen bonding.

According to an example embodiment of the present disclosure, the manufacturing method may further comprise surface-modifying the carbon material before the preparing of the carbon material solution. In some non-limiting embodiments, the carbon material may be surface-modified to form hydroxyl groups or carboxyl groups on the surface of the carbon material. In such embodiments, the surface-modified carbon material is easily dispersed, or more easily dispersed, in an aqueous solvent, (e.g., any water-soluble solvent), so that grafting may be performed efficiently, and may provide a site for binding monomers or a polymer.

According to an example embodiment of the present disclosure, the monomer may comprise N-(hydroxymethyl)acrylamide, 2-hydroxyethyl acrylate, or a combination thereof.

In one example embodiment of the present disclosure, the weight ratio of the components are not particularly limited, as long as the materials are in amounts that allow for manufacturing (e.g., proper function, optionally one or more of the advantages described herein, etc.). In some non-limiting embodiments, the carbon material, the monomers, and the initiator may be included in weight ratios falling within 1:5 to 20:0.05 to 0.2 (carbon material to monomers to initiator), and in some specific embodiments, from 1:8 to 15:0.08 to 0.15.

Hereinafter, illustrative Examples and Comparative Examples in accordance with the aspects and embodiments of the present disclosure will be described. While the following Examples are merely provided for clarity and explanation, and may include one or more preferred embodiment(s) of the present disclosure, it will be appreciated that the present disclosure, including the claims, is not limited to the following Examples.

### Example 1

0.25 wt % SWCNTs were added to a 10 wt % hydrogen peroxide aqueous solution and ultrasonicated for 5 minutes to provide surface-modified SWCNTs, which were isolated and obtained through gravity filtration, and vacuum dried at 50° C.

0.2 g of the surface-modified SWCNTs were dispersed in 100 ml of water for 30 minutes by applying ultrasonic vibration. The SWCNT dispersion was stirred at 60° C. while purging with N₂.

An amount (10 g of a 20 wt % aqueous solution) of N-(hydroxymethyl) acrylamide (HMAA) was added to the SWCNT dispersion.

Ammonium persulfate (APS) initiator (1 wt %) was added based on the weight of HMAA monomers, and the monomers were grafted at 60° C. for 24 hours. A conductive material grafted with poly (HMAA) or “PHMAA” on the SWCNT was obtained through gravity filtration and drying.

### Example 2

Using the same methodology described in Example 1, with the exception of adding 2-hydroxyethyl acrylate (HEA) instead of HMAA, a conductive material grafted with poly (HEA) or “PHEA” on SWCNT was obtained.

### Example 3

A conductive material dispersion was prepared by dispersing the conductive material prepared in Example 1 in water. Natural graphite, artificial graphite, Si/C, SiOx as negative active materials, acrylic copolymer, SBR as binders, the conductive material dispersion, and an additional conductive material were mixed in a mass ratio of 23.47:54.76:6.70:10.82:1:2:0.25:1, respectively, to prepare a slurry. The slurry was cast on a current collector using a doctor blade. The electrode was manufactured by drying the slurry at room temperature for one day and performing a pressing operation, and subsequently performing second high-temperature vacuum drying at 120° C. for 10 hours.

### Example 4

An electrode was manufactured in the same manner as in Example 3, except for incorporating the conductive material manufactured in Example 2 in place of the material from Example 1.

### Comparative Example 1

Commercial SWCNTs without grafted polymer were used as a conductive material.

### Comparative Example 2

A negative electrode was manufactured in the same manner as in Example 3, except for using the conductive material of Comparative Example 1, in place of the conductive material from Example 1.

### Experimental Example 1: Evaluation of Water Dispersibility

In order to confirm the water dispersibility of the conductive material according to the present disclosure, the conductive materials manufactured in Examples 1 and 2, and Comparative Example 1 were dispersed in water. The dispersions were photographed after sitting for 48 hours, and is shown in FIG. 2.

As may be seen in FIG. 2, the conductive material manufactured in Comparative Example 1 had extremely poor water dispersibility and thus sank in water after 48 hours. In contrast, it was confirmed that the conductive materials manufactured in Examples 1 and 2 had excellent water dispersibility and were evenly dispersed in water even after the 48 hr. rest time.

### Experimental Example 2: Confirmation of Chemical and Physical Properties of Conductive Material

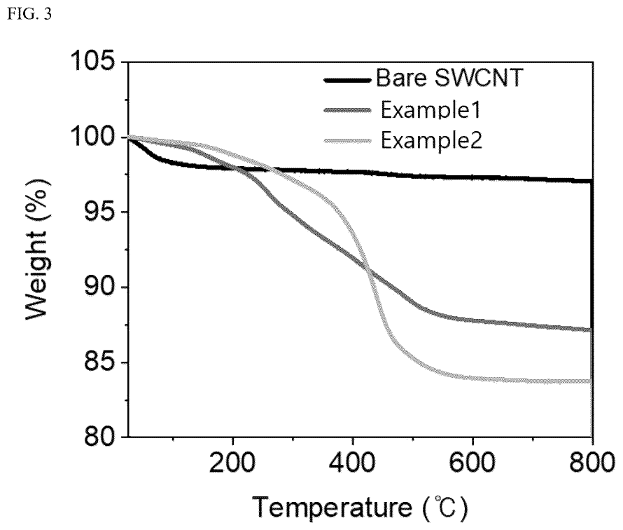

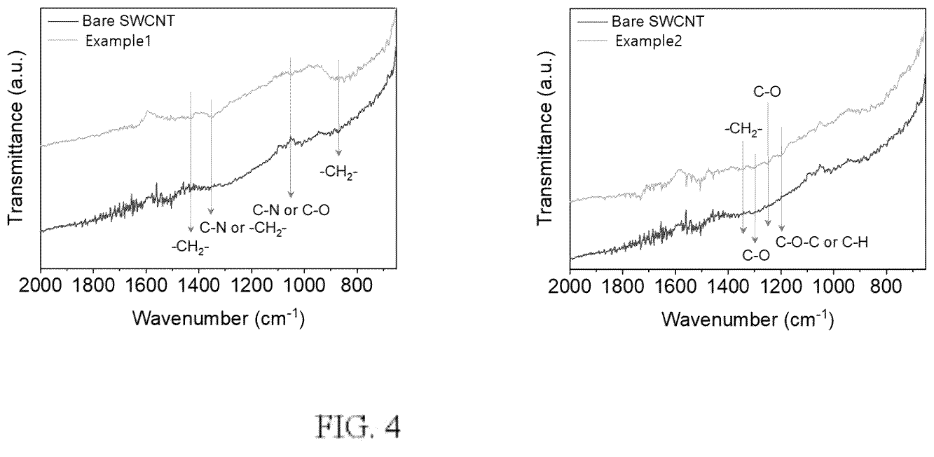

In order to confirm the chemical and physical properties of the conductive material according to the present disclosure, thermogravimetric analysis (TGA) and X-ray photoelectron spectroscopy (XPS) were performed on the conductive materials manufactured in Examples 1 and 2, and Comparative Example 1, with the results shown in FIGS. 3 and 4.

For the TGA result, the weight of the conductive material, which was a solid substance, was determined under conditions where the temperature increased in an inert gas atmosphere. In the case of Comparative Example 1, there was almost no weight change up to 800° C., but the polymer was mostly decomposed around 500° C. so that the associated weight was lost. As a result, this allowed the weights of the polymers in the conductive materials of Examples 1 and 2 to be determined.

As may be seen in FIG. 3, it was confirmed that in Example 1, the polymer showed about 9.95% polymerization, and in Example 2, the polymer showed about 13.32% polymerization.

The XPS measures the kinetic energy of electrons emitted from the surface of the material by irradiating X-rays onto a solid surface, and may identify and quantify all surface elements, except for hydrogen, through the energy and intensity of the photoelectron peaks.

As may be seen in FIG. 4, polymer comprising a functional group capable of hydrogen bonding was observed in the conductive materials of Examples 1 and 2.

### Experimental Example 3: Evaluation of Adhesion Strength of Electrode

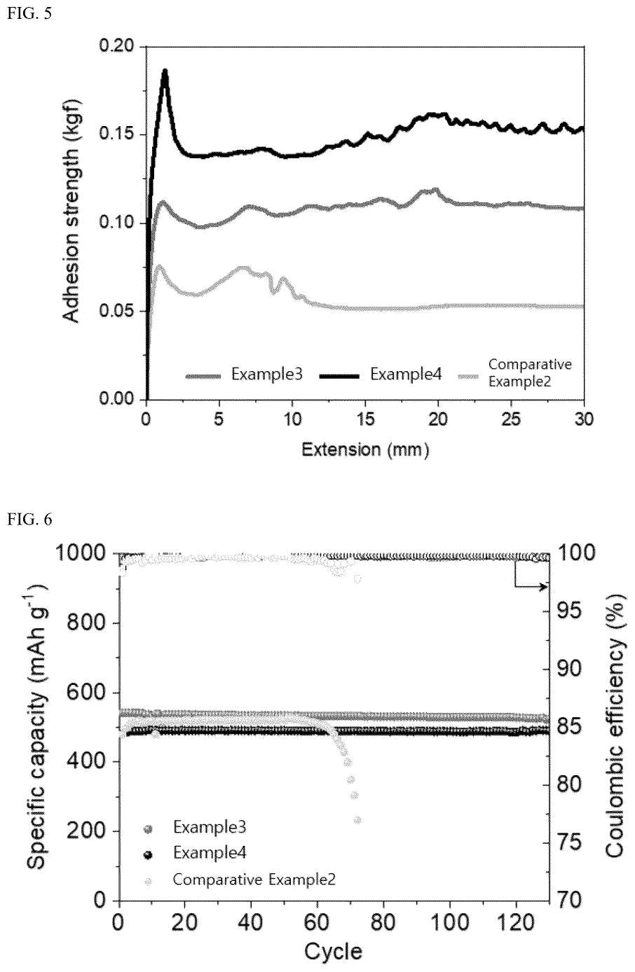

In order to evaluate the adhesion strength of electrodes comprising conductive materials according to Examples and Comparative Examples of the present disclosure, a 180° peel-off test was performed, and the results shown in FIG. 5.

As may be seen in FIG. 5, Examples 3 and 4 showed superior adhesion strength relative to Comparative Example 2. This result is believed to be associated with, at least in part, the polymers grafted to the conductive materials according to Examples of the present disclosure, which are rich in O, N, and H, and thus can form a strong attractive force by readily forming hydrogen bonds with the hydroxyl groups on the surface of the negative electrode active material and the hydroxyl groups in the binder.

### Experimental Example 4: Evaluation of Life Stability of Battery

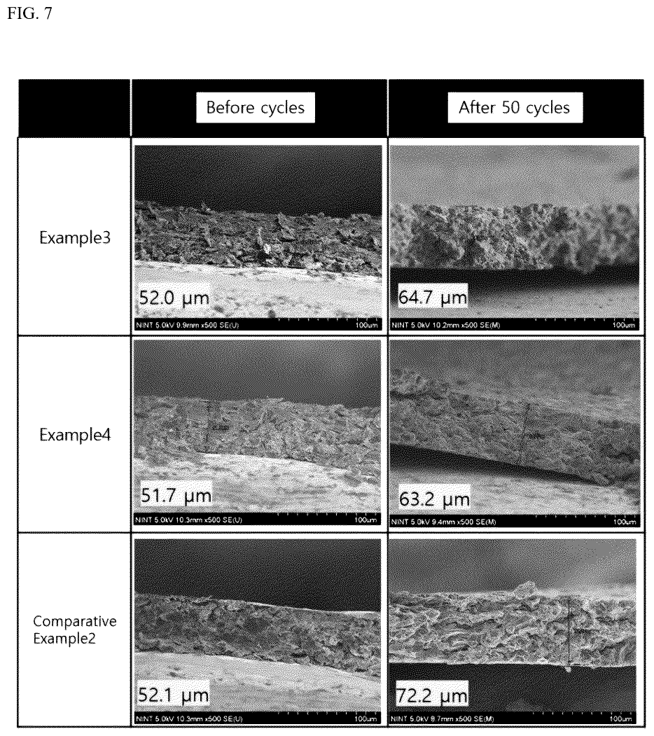

The life stability of batteries comprising the conductive materials according to Examples and Comparative Examples of the present disclosure was evaluated, and the results are shown in FIG. 6. In order to evaluate the life stability, the electrodes manufactured in Examples 3 and 4, and Comparative Example 2 were used as working electrodes, and a lithium metal disk was used as a counter electrode and a reference electrode to manufacture a half-cell in the form of a coin cell. Polypropylene was used as a separator, and LiPF₆ was used as a liquid electrolyte.

Specifically, the evaluation of the life stability was performed on electrodes having mass loading levels controlled to 8 mg/cm² and 1.55 mg/cm³ in the voltage range of 0.01 to 1.5 V at an initial formation cycle (3 cycles) (1 cycle: 0.05 C discharge, 0.02 C constant voltage, 0.1 C charge. 2 cycles; 0.1 C discharge, 0.02 C constant voltage, 0.1 C charge). In the subsequent cycles, the charge/discharge were performed at a current density of 0.2 C (discharge), 0.02 C (constant voltage), and 0.5 C (charge).

As shown in FIG. 6, the capacity retention rate of the batteries using the conductive materials according to Examples was approximately 85%, and contrasts from the Comparative Examples, where the capacity retention rate observably decreased rapidly after 60 cycles. Therefore, it may be seen that the battery comprising the conductive material of the present disclosure may exhibit excellent life stability by self-healing any of the defects that may be caused by the volume expansion of the negative electrode that can occur during the charge/discharge process.

### Experimental Example 5: Evaluation of Extension of Electrode

The degree of extension of electrodes comprising the conductive materials according to Examples and Comparative Examples of the present disclosure was evaluated, and the results were shown in FIG. 7. Specifically, the half-cell manufactured in Experimental Example 4 was disassembled after 50 cycles of operation, and the degree of extension of electrodes was confirmed through SEM.

As may be seen in FIG. 7, in Examples 3 and 4, the extension degrees of the electrodes after 50 cycles were 24% and 22%, respectively, but the electrode extension degree of Comparative Example 2 was 38%. This is most likely because bare SWCNTs, which are non-treated conductive materials, do not form chemical interactions (such as hydrogen bonds) with silicon and binders, and thus do not alleviate large volume changes in silicon particle units and electrode units.

### Experimental Example 6: Evaluation of Impedance of Battery

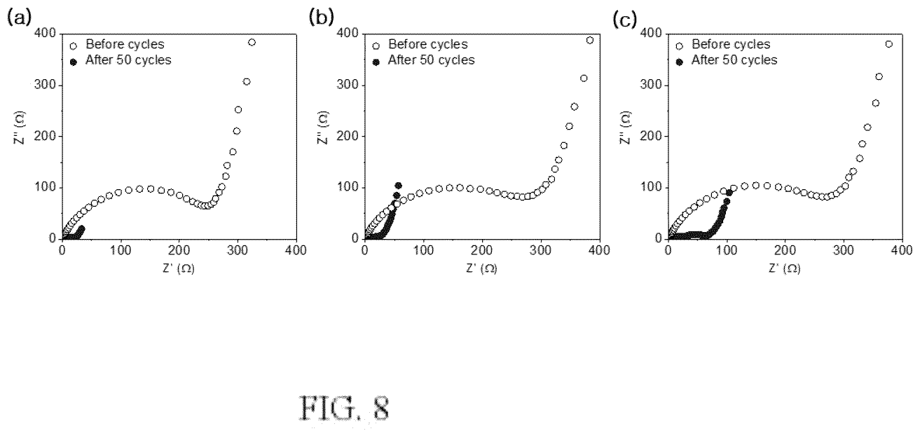

The impedance performance of batteries comprising the conductive materials according to Examples and Comparative Examples of the present disclosure was evaluated, and the results are shown in FIG. 8 and Table 1. Specifically, the evaluation of impedance performance was performed by measuring the resistance of the half-cell manufactured in Experimental Example 4 before cycles and after 50 cycles using electrochemical impedance spectroscopy (EIS) under the same charge/discharge conditions and frequency range.

TABLE 1

R_{SEI} + R_{ct} (Ω)

| | Before cycles | After 50 cycles |
|---|---|---|
| Example 3 | 269.0 | 22.31 |
| Example 4 | 304.5 | 26.03 |
| Comparative Example 2 | 313.2 | 60.02 |

As may be seen in Table 1 and FIG. 8, Comparative Example 2 showed a greater resistance than Examples 3 and 4 both before and after cycles. The greater resistance is caused by a thick and unstable SEI resistance layer due to the structural collapse of silicon during the repeated charge/discharge process (lithiation/delithiation). In contrast, in the case of the illustrative Examples, it was observed that the resistance remains low even after 50 cycles. This may be due at least in part because the conductive materials in Examples of the present disclosure may maintain the integrity of the electrode by healing the silicon structure collapsed during the charge/discharge process.

Features, structures, effects, and the like described in the above-described embodiments are comprised in at least one embodiment of the present disclosure and are not necessarily limited to one embodiment. Furthermore, in light of the above disclosure and without departing from it, one of skill in the art may take one or more of the features, structures, effects, and the like illustrated in each embodiment, and combine or modify them with other embodiments that are known to in the art to which the embodiments pertain. Accordingly, the contents related to these combinations and modifications should be interpreted to cover the entire scope of the present disclosure.

1. A conductive material comprising:
a polymer comprising a functional group capable of hydrogen bonding; and
a carbon material grafted with the polymer containing the functional group capable of hydrogen bonding.

2. The conductive material of claim 1, wherein the carbon material comprises at least one of single-walled carbon nanotubes, carbon black, and/or carbon fibers.

3. The conductive material of claim 2, wherein the single-walled carbon nanotubes comprise hydroxyl group and/or carboxyl group surface modifications.

4. The conductive material of claim 1, wherein the functional group capable of hydrogen bonding comprises at least one of hydroxyl groups, amide groups, and/or ester groups.

5. The conductive material of claim 1, wherein the polymer containing the functional group capable of hydrogen bonding comprises repeating units represented by at least one of Chemical Formula 1 or Chemical Formula 2: 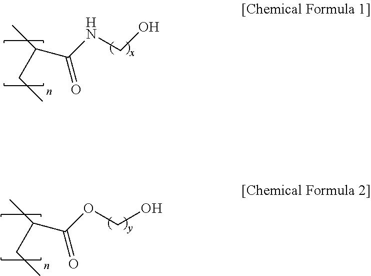
wherein,
x and y are each independently integers of 1 to 6, and
n is 1 to 20.

6. The conductive material of claim 1, wherein the conductive material comprises 1 to 30 parts by weight of the polymer containing the functional group capable of hydrogen bonding with respect to 100 parts by weight of the carbon material.

7. A negative electrode comprising the conductive material according to claim 1; and a binder.

8. The negative electrode of claim 7, wherein the conductive material comprises 1 to 30 parts by weight of the polymer containing the functional group capable of hydrogen bonding with respect to 100 parts by weight of the carbon material.

9. The negative electrode of claim 7, wherein the binder forms hydrogen bonds with the conductive material.

10. A lithium ion battery comprising the negative electrode according to claim 7.

11. A negative electrode comprising the conductive material according to claim 2; and a binder.

12. The negative electrode of claim 11, wherein the binder forms hydrogen bonds with the conductive material.

13. A lithium ion battery comprising the negative electrode according to claim 11.

14. A negative electrode comprising the conductive material according to claim 5; and a binder.

15. The negative electrode of claim 14, wherein the binder forms hydrogen bonds with the conductive material.

16. A lithium ion battery comprising the negative electrode according to claim 14.

17. A manufacturing method of a conductive material comprising:
preparing a carbon material solution by mixing a carbon material with a solvent;
preparing a grafted solution comprising grafting polymer monomer units onto the carbon material by adding the polymer monomer units to the carbon material solution; and
polymerizing a the polymer monomer units by adding an initiator to the grafted solution,
wherein the polymer monomer units contain a functional group capable of hydrogen bonding.

18. The manufacturing method of claim 17, further comprising:
surface-modifying the carbon material before preparing of the carbon material solution.

19. The manufacturing method of claim 17, wherein the polymer monomer units comprises N-(hydroxymethyl)acrylamide, 2-hydroxyethyl acrylate, or a combination thereof.

20. The manufacturing method of claim 17, wherein the weight ratio of the carbon material, the polymer monomer units, and the initiator is 1:5 to 20:0.05 to 0.2, (carbon material to polymer monomer units to initiator).
